(19) United States
(12) Patent Application Publication
(10) Pub. No.: US 2017/0249601 A1
(43) Pub. Date: Aug. 31, 2017

(54) Method for Facilitating Recycling

(71) Applicant: Simple Green Co., Ltd., Huatan Township (TW)

(72) Inventors: Chen-I Kao, Huatan Township (TW); Shang-Chieh Kao, Huatan Township (TW); Shu-Chen Huang, Huatan Township (TW); Yu-Chuan Wu, Huatan Township (TW); Hsueh-Fang Kao, Douliou City (TW); Yung-Ping Lai, Huatan Township (TW); Boghosian Glenn Malcolm, Beverly Hills, CA (US)

(21) Appl. No.: 15/435,490

(22) Filed: Feb. 17, 2017

(30) Foreign Application Priority Data
Feb. 26, 2016 (TW) 105105908

(51) Int. Cl. G06Q 10/00; G06K 7/10

(52) U.S. Cl. CPC G06Q 10/30; G06K 7/10297

(57) ABSTRACT

A method for facilitating recycling includes steps of producing an object that corresponds to a brand and that includes identification information associated with the object; by a terminal device that is placed in a dealer shop associated with the brand, receiving the identification information from the object, and transmitting the identification information to a server that is communicatively coupled to the terminal device through a communication network; and (c) by the server, identifying the object according to the identification information and transmitting an identification result that corresponds to the object to the terminal device.

### CROSS-REFERENCE TO RELATED APPLICATION

This application claims priority of Taiwanese Patent Application No. 105105908, filed on Feb. 26, 2016.

### FIELD

The disclosure relates to a method for facilitating recycling, and more particularly to a method for facilitating recycling of an object by sensing identification information of the object.

### BACKGROUND

In order to reduce environmental burden resulting from garbage, recycling has been promoted for years. Recycling companies collect and resell various recyclable materials to green technology companies for conversion into reusable matter. Currently, brand dealers that sell commodities do not contribute to the recycling process.

In addition, there is no motivation for consumers to actively recycle commodities that will no longer be used, resulting in poor recycling efficiency.

### SUMMARY

Therefore, an object of the disclosure is to provide a method for facilitating recycling.

According to the disclosure, the method includes steps of: (a) producing an object that corresponds to a brand and that includes identification information associated with the object; (b) by a terminal device that is placed in a dealer shop associated with the brand, receiving the identification information from the object, and transmitting the identification information to a server that is communicatively coupled to the terminal device through a communication network; and (c) by the server, identifying the object according to the identification information and transmitting an identification result that corresponds to the object to the terminal device.

### BRIEF DESCRIPTION OF THE DRAWINGS

Other features and advantages of the disclosure will become apparent in the following detailed description of the embodiment (s) with reference to the accompanying drawings, of which:

FIG. 1 is a block diagram illustrating devices used to implement an embodiment of the method for facilitating recycling according to the disclosure;

FIG. 2 is a flow chart illustrating steps of the embodiment; and

FIG. 3 illustrates advantages of the embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

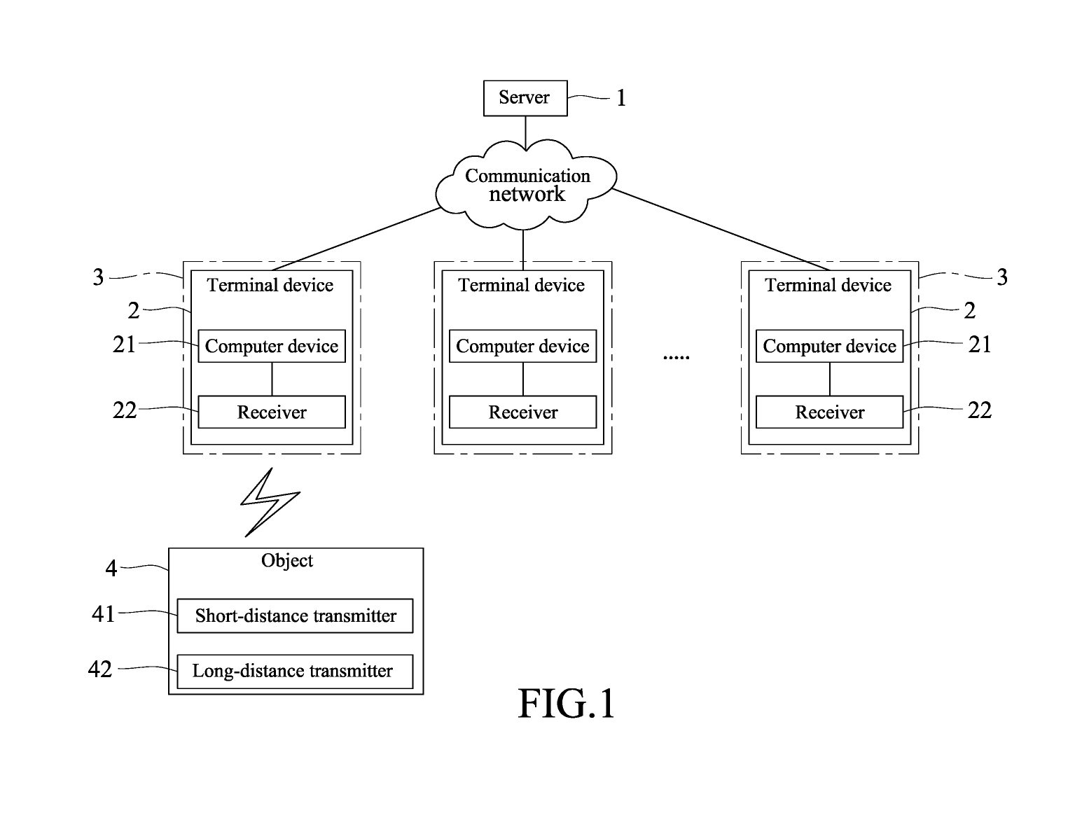

Referring to FIG. 1, the embodiment of the method for facilitating recycling of an object 4 according to this disclosure is implemented using a server 1 and terminal devices 2 each being communicatively coupled to the server 1 through a communication network. The object 4 corresponds to a brand, is produced to include first identification information and second identification information that are both associated with the object 4, a short-distance transmitter 41 that is configured to wirelessly transmit the first identification information, and a long-distance transmitter 42 that is configured to wirelessly transmit the second identification information. In this embodiment, the transmitter 41 has an effective signal transmission distance/range shorter than that of the transmitter 42. In one example, the object 4 is a pair of shoes, and the transmitters 41 and 42 may be embedded in the soles of the shoes.

The first identification information includes category information and model information that correspond to the object 4, and the second identification information also includes the category information and the model information. Each terminal device 2 is placed in a respective dealer shop 3 associated with the brand, and includes a computer device 21 and a receiver 22 that is coupled to the computer device 21 and that is configured to wirelessly receive the first and second identification information. In this embodiment, the receiver 22 is a radio frequency identification (RFID) reader; the short-distance transmitter 41 is a passive RFID tag which is battery-less and which is configured to be triggered by the receiver 22 when located within a specific distance, for example, one meter, from the receiver 22 for wireless transmission of the first identification information, so the receiver 22 receives the first identification information therefrom; and the long-distance transmitter 42 is an active RFID tag which includes a battery and which is configured to actively, wirelessly and periodically transmit the second identification information, so the receiver 22 receives the second identification information when located within a specific distance, for example, two hundred meters, from the long-distance transmitter 42. The server 1 stores object history information that corresponds to the object 4, and that may include the category information, the model information, a manufacturing date, a recommended expiry date, etc.

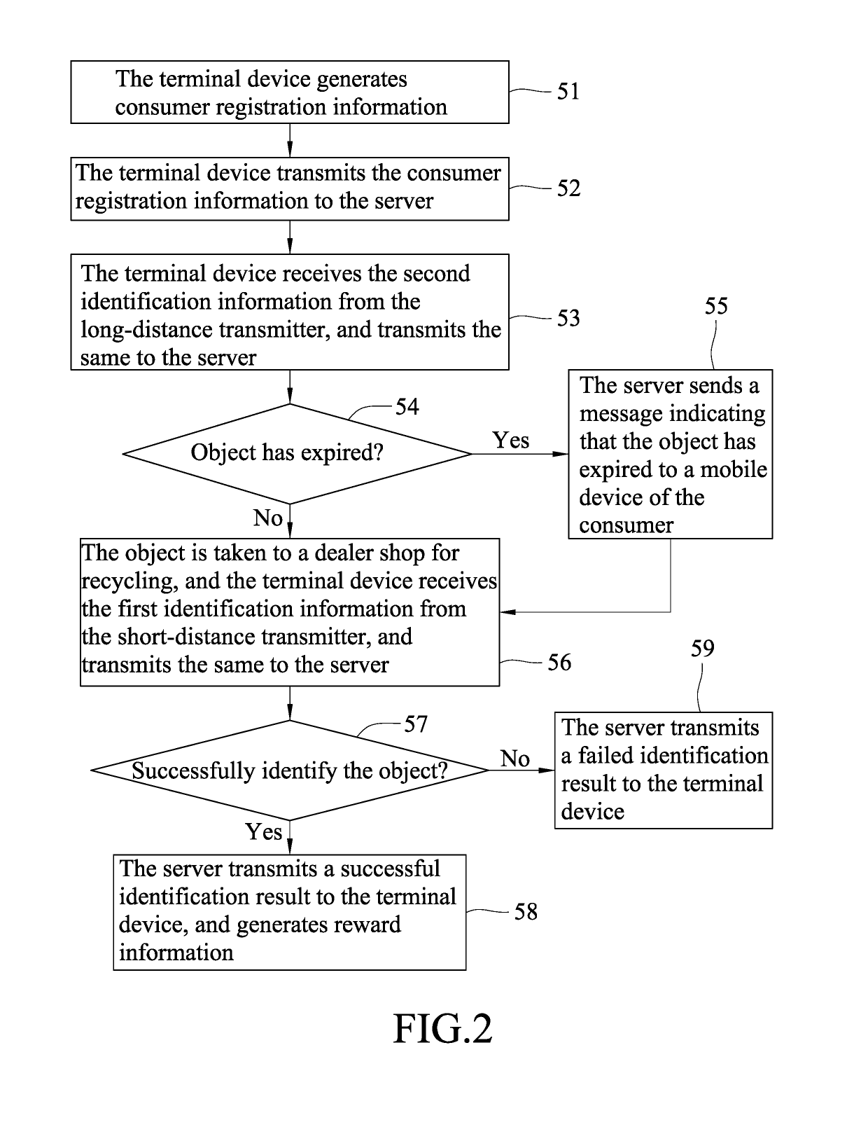

Further referring to FIG. 2, an embodiment of the method according to this disclosure is shown to include steps 51-59. In step 51, a consumer purchases the object 4 in one of the dealer shops 3 associated with the brand, and makes a registration with the brand so that the computer device 21 of the dealer shop 3 generates consumer registration information and associates the same with the first and second identification information of the object 4. The consumer registration information may include personal information of the consumer, the category information and the model information of the object 4, device information (e.g., a mobile phone number) of the consumer, etc.

In step 52, the computer device 21 transmits the consumer registration information to the server 1 for storage therein.

When the consumer takes the object 4 and for instance, walks in a vicinity of one of the dealer shops 3 so that the dealer shop 3 is within an effective signal transmission range of the long-distance transmitter 42, the terminal device 2 in the one of the dealer shop 3 receives the second identification information through the receiver 22, and transmits the second identification information to the server 1 (step 53). In the case that the object 4 is the pair of shoes, when the consumer puts on the shoes and walks in a vicinity of one of the dealer shops 3, the terminal device 2 that is placed. in the dealer shop 3 may receive the second identification information since the long-distance transmitter 42 of the shoes (i.e., the object 4) actively, periodically and wirelessly transmits the second identification information. Then, the terminal device 2 transmits the second identification information to the server 1.

In step 54, if the server 1 successfully identifies the object 4 by comparing the object history information and the second identification information after receipt of the second identification information, the server 1 further determines whether or not the object 4 has expired. according to the recommended expiry date. The flow goes to step 55 when the determination is affirmative, and goes to step 56 when otherwise.

In step 55, the server 1 sends a message which indicates that the object 4 has expired to the consumer's mobile device according to the device information of the consumer registration information.

In the case that the object 4 is the pair of shoes, when the consumer puts on the shoes which have exceeded the recommended expiry date and walks in a vicinity of one of the dealer shops 3, the consumer's mobile device may receive a message which indicates that the shoes have expired from the server 1. In one embodiment, the message further includes an address of the dealer shop 3, so that the consumer is made aware of the presence of the dealer shop 3 nearby, thereby enhancing motivation of the consumer to go into the dealer shop 3 for recycling the shoes and even buying another pair.

When the consumer is motivated by the message and takes the object 4 to one of the dealer shops 3 for recycling, a staff of the dealer shop 3 may operate the terminal device 2 so the terminal device 2 receives the first identification information transmitted by the short-distance transmitter 41, and the computer device 21 transmits the first identification information to the server 1 (step 56).

In step 57, the server 1 identifies whether or not the object 4 is a product of the brand or was sold by a dealer of the brand according to the first identification information. The flow goes to step 58 when the server 1 successfully identifies the object 4 (i.e., identifying that the object 4 is a product of the brand or was sold by a dealer of the brand) according to the first identification information, and goes to step 59 when the server 1 does not successfully identify the object 4 (i.e., the server 1 cannot identify that. the object 4 is a product of the brand or was sold by a dealer of the brand) according to the first identification information.

In step 58, the server 1 transmits a successful identification result to the terminal device 2, generates reward information (e.g., bonus points, electronic coupons, etc.) corresponding to the category information and the model information, and records the reward information in the consumer registration information.

In step 59, the server 1 transmits a failed identification result, which indicates that the server 1 was unable to identify the object 4 to the terminal. device 2.

If the consumer wishes to recycle an object 4 which has not expired, the consumer may still take the object 4 to one of the dealer shops 3 for recycling the same and thus acquiring the reward information as mentioned in steps 56-58 without having received the message which indicates that the object 4 has expired. Accordingly, even if the object 4 includes only the short-distance transmitter 41 to transmit the first identification information and omits the long-distance transmitter 42 that transmits the second identification information, the recycling of the object 4 in accordance with this disclosure may still be performed in the dealer shops 3.

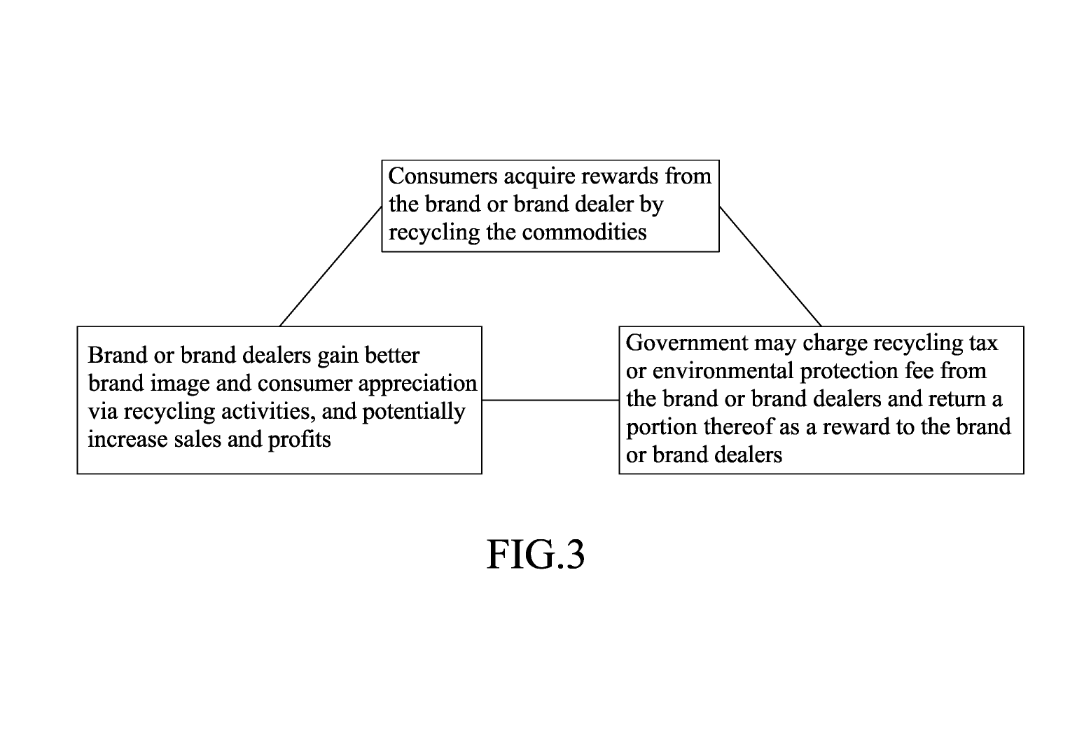

In this embodiment, provision of the reward information after recycling of the object 4 may enhance motivation of the consumer to recycle the object 4. Furthermore, increase in number of the dealer shops 3 may facilitate recycling of the object 4 by consumers, thereby promoting recycling efficiency, and dealers of the brand may have more contribution to recycling and environmental protection, fulfilling corporate social responsibility. Referring to FIG. 3, the embodiment not only promotes recycling efficiency and reduces garbage, and may also accomplish the following advantages for consumers, the government and the brand dealers.

1. Consumers may acquire rewards from the brand or brand dealers by recycling commodities sold of the brand or sold by the brand dealers, thereby enhancing motivation to recycle.

2. Recycling activities may promote brand image and consumer appreciation. In addition, consumers may also purchase other commodities when visiting the dealer shops 3 to recycle the objects 4. As a result, the brand dealers may achieve better sales and profits.

3. The government that charges recycling tax or environmental protection fee from the brand or brand dealers may refund a portion of the charge to the brand or brand dealers to serve as a reward for recycling.

In one embodiment, the consumer may purchase the object 4 via an electronic commerce platform (e.g., “Yahoo!”, “Amazon.com”, etc.) that is communicatively coupled to the server 1 through the communication network, and input the consumer registration information through the electronic commerce platform, so the electronic commerce platform generates the consumer registration information and transmits the same to the server 1 for storage therein. In other words, the consumer may purchase the object 4 on the electronic commerce platform, and recycle the object 4 in one of the dealer shops 3.

In one embodiment, the object 4 may include only the long-distance transmitter 42 to transmit the second identification information and omit the short-distance transmitter 41 that transmits the first identification information. In addition to being used in determining whether or not the object 4 has expired, the second identification information is used for identifying the object 4 when the consumer takes the object 4 to the dealer shop 3 for recycling. In this embodiment, the battery for the transmitter 42 may be a long-lasting battery, so as to prevent the transmitter 42 from having no power when the object 4 is to be recycled in the dealer shop 3. In one embodiment, the object 4 may further include a micro vibration power generator (not shown) to provide electrical power for the battery. In the case that, the object 4 is the pair of shoes, the vibration power generator maybe embedded in the soles of the shoes, so the vibration power generator generates electrical power to charge the battery of the transmitter 42 when the consumer walks in the shoes.

In one embodiment, the object 4 includes a barcode containing the first identification information, and each terminal device 2 further includes a barcode scanner (not shown). In this configuration, the object 4 may be identified by the barcode scanner scanning the barcode to acquire the first identification information even if the transmitters 41, 42 become nonfunctional.

In one embodiment, a portion of the object 4 may be made of a specific material, so that the object 4 may be identified by identifying the specific material when the transmitters 41, 42 become nonfunctional. In the case that the object 4 is the pair of shoes, the vamps of the shoes may be made of a biomaterial so the shoes may be identified by sensing protease included in the vamps; the vamps of the shoes may be made of a composite material, such as being woven with steel wires, so the shoes may be identified by sensing a ratio of the alloy components in the steel wires; or the vamps of the shoes may be made of a material having a particular compound formula design, so the shoes may be identified by identifying the compound.

In summary, the method according to this disclosure facilitates recycling by producing commodities with identification information and placing the terminal devices 2 in the dealer shops 3 to identify the commodities according to the identification. The method according to this disclosure further promotes recycling efficiency by using the long-distance transmitter 42 to wirelessly transmit the second identification information, and by the terminal device 2 sending the message to notify that the commodity has expired according to the second identification information. Furthermore, the method according to this disclosure enhances motivation of the consumer to recycle by the server 1 giving the rewards to the consumer for recycling.

In the description above, for the purposes of explanation, numerous specific details have been set forth in order to provide a thorough understanding of the embodiment(s). It will be apparent, however, to one skilled in the art, that one or more other embodiments may be practiced without some of these specific details It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for facilitating recycling, said method comprising steps of:
(a) producing an object that corresponds to a brand and that includes identification information associated with the object;
(b) by a terminal device that is placed in a dealer shop associated with the brand, receiving the identification information from the object, and transmitting the identification information to a server that is communicatively coupled to the terminal device through a communication network; and
(c) by the server, identifying the object according to the identification information and transmitting an identification result that corresponds to the object to the terminal device.

2. The method of claim 1, wherein step (a) includes producing the object that further includes a transmitter configured to wirelessly transmit the identification information;
wherein the terminal device includes a receiver, and step (b) includes the receiver of the terminal device wirelessly receiving the identification information from the transmitter of the object.

3. The method of claim 2, wherein step (a) includes producing the object that further includes another identification information, and another transmitter configured to wirelessly transmit the another identification information associated with the object;
wherein an effective signal transmission distance of the transmitter is shorter than that of the another transmitter; and
wherein the server includes consumer registration information that corresponds to the another identification information and a mobile device;
said method further comprising steps of:
(d) upon receipt of the another identification information by the receiver of the terminal device wirelessly, the terminal device transmitting the another identification information to the server; and
(e) upon the server determining that the object has expired according to the another identification information, the server sending a message which indicates that the object has expired to the mobile device according to the device information.

4. The method of claim 3, wherein the transmitter is a passive radio frequency identification (RFID) tag, the another transmitter is an active RFID tag, and the receiver is an RFID reader.

5. The method of claim 3, further comprising a step of:
(f) by one of the terminal device and a terminal device that is placed in another dealer shop associated with the brand and that is communicatively coupled to the server through the communication network, generating the device information and transmitting the device information to the server for storage therein.

6. The method of Clam 3, further comprising a step:
(f) by an electronic commerce platform that is communicatively coupled to the server through the communication network, generating the device information and transmitting the device information to the server for storage therein.

7. The method of claim 2, wherein the server includes consumer registration information that corresponds to the identification information and a mobile device;
said method further comprising a step of:
(d) upon the server determining that the object has expired according to the identification information, the server sending a message which indicates that the object has expired to the mobile device according to the device information.

8. The method of claim 7, wherein the transmitter is an active radio frequency identification (RFID) tag, and the receiver is an RFID reader.

9. The method of claim 7, further comprising a step of:
(f) by one of the terminal device and a terminal device that is placed in another dealer shop associated with the brand and that is communicatively coupled to the server through the communication network, generating the device information and transmitting the device information to the server for storage therein.

10. The method of claim 7, further comprising a step of:
(f) by an electronic commerce platform that is communicatively coupled to the server through the communication network, generating the device information and transmitting the device information to the server for storage therein.

11. The method of claim 1, wherein the identification information includes category information and model information corresponding to the object, and the server includes consumer registration information corresponding to the identification information;
said method further comprising a step of:
(d) upon the server successfully identifying the object according to the identification information, the server generating reward information corresponding to the category information and the model information, and recording the reward information in the consumer registration information.

12. The method of claim 1, wherein step (a) includes producing the object that further includes a barcode containing the identification information; the terminal device further includes a barcode scanner; and step (b) includes the terminal device receiving the identification information through the barcode scanner scanning the barcode, and transmitting the identification information to the server through the communication network.
